(19) United States
(12) Patent Application Publication
(10) Pub. No.: US 2005/0012234 A1
(43) Pub. Date: Jan. 20, 2005

(54) Method for making cushioned products with an integral cover

(76) Inventors: Alan L. Kindig, Holland, MI (US); Steven J. Gager, Holland, MI (US)

Correspondence Address: Waters & Morse, P.C., 400 Ledyard Building, 125 Ottawa, N.W., Grand Rapids, MI, 49503, US

(21) Appl. No.: 10/871,435

(22) Filed: Jun. 18, 2004

Related U.S. Application Data
(60) Provisional application No. 60/479,500, filed on Jun. 18, 2003.

(51) Int. Cl. B29C 44/06

(52) U.S. Cl. 264/46.4

(57) ABSTRACT

A process for producing a cushioned product having a foam core and integral cover comprises molding a formed cover from a substantially non-porous, formable sheet material in a flexible bladder vacuum forming operation, and then injecting a reactive liquid foam into an open interior of the cover in a reaction injection mold. In one embodiment, the cover comprises an adhesively formed laminate having a porous fabric outer layer and a substantially non-porous thermo formable closed cell inner layer. In another embodiment, the cover is formed of a sheet of polyvinyl chloride having a decorative exterior finish. In either case, the cover, is sufficiently thin and flexible that the cover is readily formable and does not adversely impair the softness characteristics of the foam cushion core.

### CROSS-REFERENCES TO RELATED APPLICATIONS

This is a non-provisional application based on and claiming the filing priority of co-pending provisional patent application Ser. No. 60/479,500, filed Jun. 18, 2003.

### BACKGROUND OF THE INVENTION

The present invention relates to the manufacture of cushioned products wherein a foam cushion core is integrally formed with a fabric or other outer surface layer. One application of the present invention is for the manufacture of furniture components, such as armrests or seating or similar applications.

The traditional method of manufacturing an armrest for an office chair or the like is to mold a form core and then manually apply a fabric or other outer decorative layer to the core by wrapping the fabric around the core, with an outer edge of the fabric extending under the armrest, and then stapling the wrapped edge to a substrate on the underside of the armrest. This is a labor intensive procedure and produces a product that is sometimes less than perfectly formed. In addition, the incorporation of staples in an otherwise plastic product makes the product non-recyclable.

Another process that has been used for manufacturing cushioned products with an integral surface layer involves first injection or blow molding a PVC skin and then backmolding the skin with a moldable foam. An injection molded PVC skin, however, has some aesthetic and environmental limitations. This process has not been used successfully for cushions having fabric or other non-injection molded covers.

Fabric covered surfaces have been integrally molded with injection molded plastic panels and other somewhat rigid core materials. However, fabrics have been less successfully molded into foam cushions, where the covers need to have softness characteristics comparable to the foam, as well as blow by and bleed through prevention properties that restrain the foam from flowing around or through the fabric when in its liquid state.

An object of the present invention is to provide a product and molding process for producing an armrest or other cushioned product that integrally incorporates a non-injection or blow molded fabric or other desirable surface covering and retains the resilient feel of the cushioning material without the use of staples and without the necessity of a separate operation to apply the covering material to the underlying armrest.

### BRIEF SUMMARY OF THE INVENTION

In accordance with the present invention, a process for producing a cushioned product having a foam core and integral cover comprises molding a formed cover from a substantially non-porous formable sheet material in a flexible bladder forming operation, such that the formed shape includes an open interior for an integral foam core. The formed cover is then placed in a mold cavity of a low pressure reaction injection mold, and a reactive liquid foam is injected into the open interior of the cover. The mold is held in its closed position until the foam expands to substantially fill the open interior of the cover and the foam cures such that the foam core and cover become integrally attached without the use of fasteners. The foam core and cover are then removed from the mold as an integral product.

In one aspect of the invention, the cover comprises a laminate having a porous fabric outer layer and a thermo formable closed cell foam inner layer, preferably polypropylene or a composite of polypropylene and polyethylene. The layers can be adhesively laminated together. The inner layer is sufficiently flexible that the inner layer does not adversely impair the softness characteristics of the foam cushion core. The inner layer also is sufficiently non-porous that liquid foam does not bleed through the fabric before the foam has cured. Desirably, the inner layer is about 0.75 to 2.0 millimeters thick.

In another aspect of the invention, the cover is formed of polyvinyl chloride in a sheet between about one and two millimeters thick.

The foregoing process produces a cushioned product having a superior feel in a single integral manufacturing operation. Hand labor is minimized and the finished product employs no staples and is recyclable.

These and other features and advantages of the present invention are described in detail below and shown in the appended drawings.

### BRIEF DESCRIPTION OF THE SEVERAL VIEWS OF THE DRAWING

FIG. 1 is a schematic sectional view of a cover mold used to mold the cover or skin of an armrest in accordance with the present invention, with the mold being shown in a separated state.

FIG. 2 is a view of the mold in FIG. 1 with a blank formed of a fabric covered formable material being positioned in the mold prior to the molding process.

FIG. 3 is a view as in FIG. 2 wherein the form tool is inserted further into the mold cavity.

FIG. 4 is a view as in FIG. 3 wherein the form tool is inserted further into the mold cavity and a resilient bladder is drawn by vacuum into conformity with the form tool, with the formable material being positioned between the bladder and the form tool.

FIG. 5 is a view as in FIG. 4 wherein the bladder is drawn by vacuum away from the form tool and the formed cover or skin.

FIG. 6 is a view as in FIG. 5 wherein the form tool has been removed from the mold cavity.

FIG. 7 is a view of the form tool as in FIG. 6, with the molded cover being resiliently removed from the form tool.

FIG. 8 is a sectional view of the formed cover or skin, with a mounting flange in the form of a molded plastic substrate being adjacent an inner edge of the cover.

FIG. 9 is a sectional side elevational view of a product mold shown in an open condition, with the formed cover or skin being mounted in the product mold cavity.

FIG. 10 is a view of the product mold of FIG. 9, showing the mold in a closed position, with the mold cavity having been filled with a two component reactive (expandable) polyurethane foam.

FIG. 11 is a sectional view of the completed armrest removed from the mold of FIG. 10.

FIG. 12 is a cross sectional view of the armrest of FIG. 11, shown mounted on the arm of a chair.

### DETAILED DESCRIPTION OF PREFERRED EMBODIMENT

The present invention is particularly useful in the production of contoured foam cushions having a fabric or other decorative cover. Foam cushions for armrests in furniture or similar applications are particularly desirable uses of the invention. However, the method of the present invention can be used to produce other cushioned products wherein a decorative fabric or other formable, non-injection or blow molded exterior surface is applied to a molded core formed of a foam cushion material, such as polyurethane foam. For purposes of illustration, the present invention will be described in the context of the fabrication of a molded armrest.

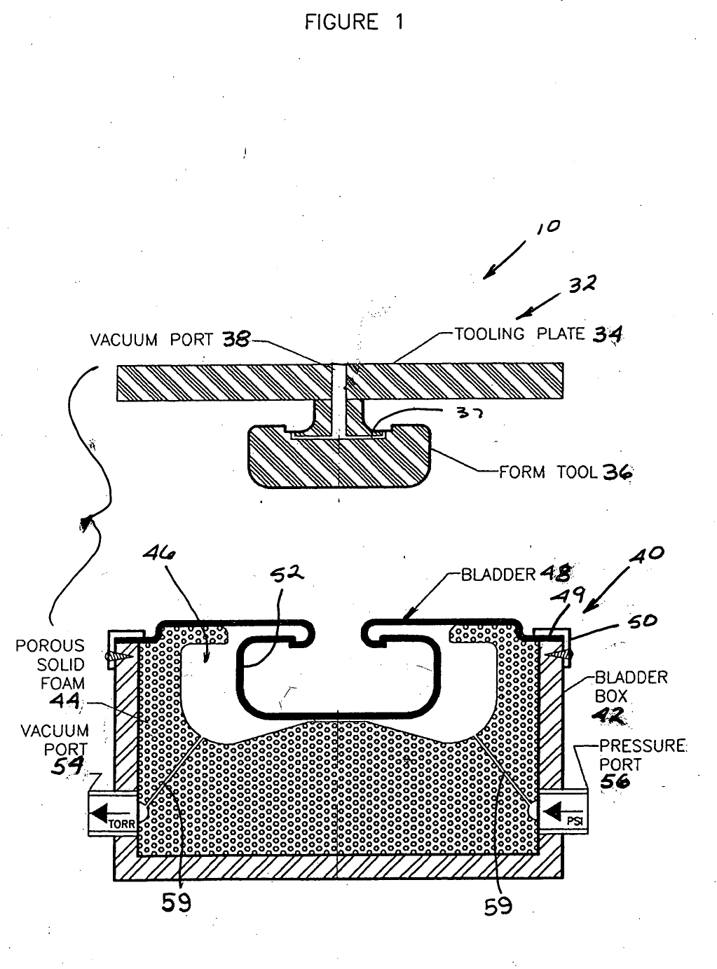

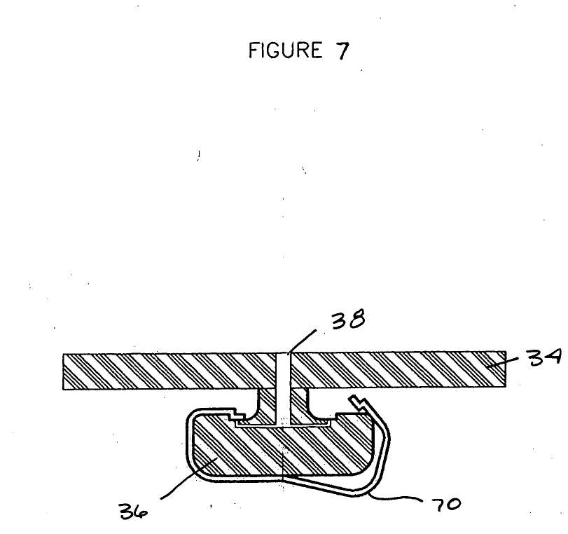

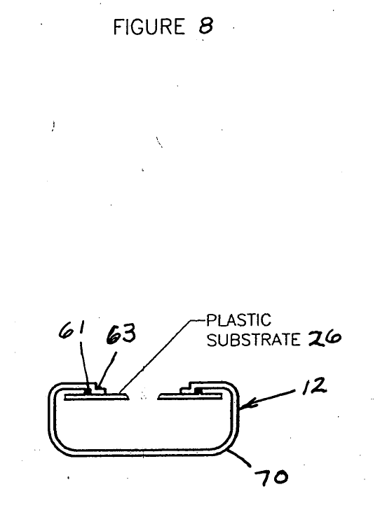

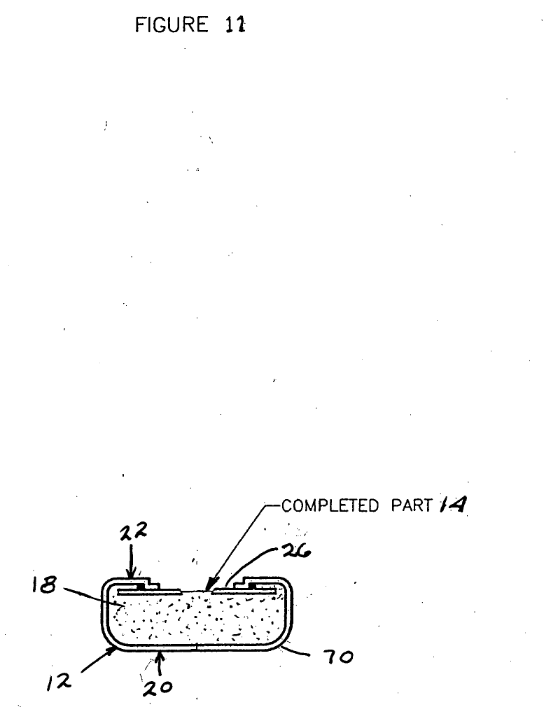

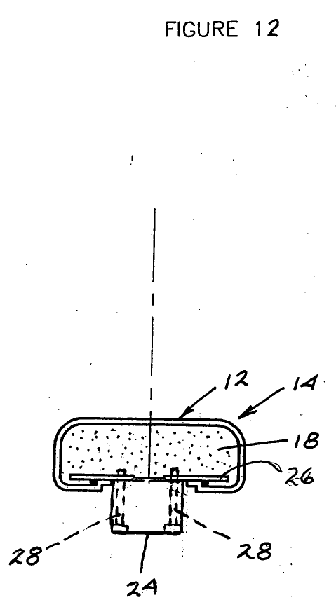

Referring now to the drawings, FIGS. 1-7 disclose the tooling or mold 10 and sequential operation thereof for the production of a cover 12 (see FIG. 8) of a product such as armrest 14 (see FIG. 11). Armrest 14 includes cover 12 and an integrally formed polyurethane foam core 18. The armrest has an outer side 20 that is exposed to user contact and visibility and an inner side 22 that is mounted on a support structure such as the arm 24 of a chair (FIG. 12). Armrest 14 is shown in the orientation in which it is used in FIG. 12. The armrest is shown in the orientation it occupies in the molding process in FIGS. 1-11, which is opposite to the orientation of FIG. 12. For purposes of convenience, the upper side 20 of armrest 14 (FIG. 12 orientation) is referred to as the outer side of the arm rest, whereas the lower side 22 attached to the arm of the chair is referred to as the inner side.

The armrest 14 is attached to arm 24 of the chair by means of a substrate 26 in the form of a peripheral flange that is attached to the inner side of the armrest and incorporated therein. Fasteners 28 (FIG. 12) can be used to attach the armrest to the arm 24 of the chair. The fasteners can be threaded fasteners that are threaded through the substrate, or the fasteners can engage nuts incorporated in the substrate. The substrate and fasteners are conventional and can vary. The substrate typically is formed of injection molded plastic.

Referring to FIGS. 1-7, the molding equipment for forming the armrest cover 12 comprises mold 10, which includes a male mold component 32 and a female mold component 40.

Male mold 32 includes a tooling plate 34 and a form tool 36 attached to the underside of the tooling plate. A vacuum port 38 in the tooling plate and form tool makes it possible to draw a vacuum from the upper side of the vacuum plate through vacuum holes 37 in form tool 36. Vacuum holes 37 branch out from the main vacuum port 38 and encircle the entire form tool.

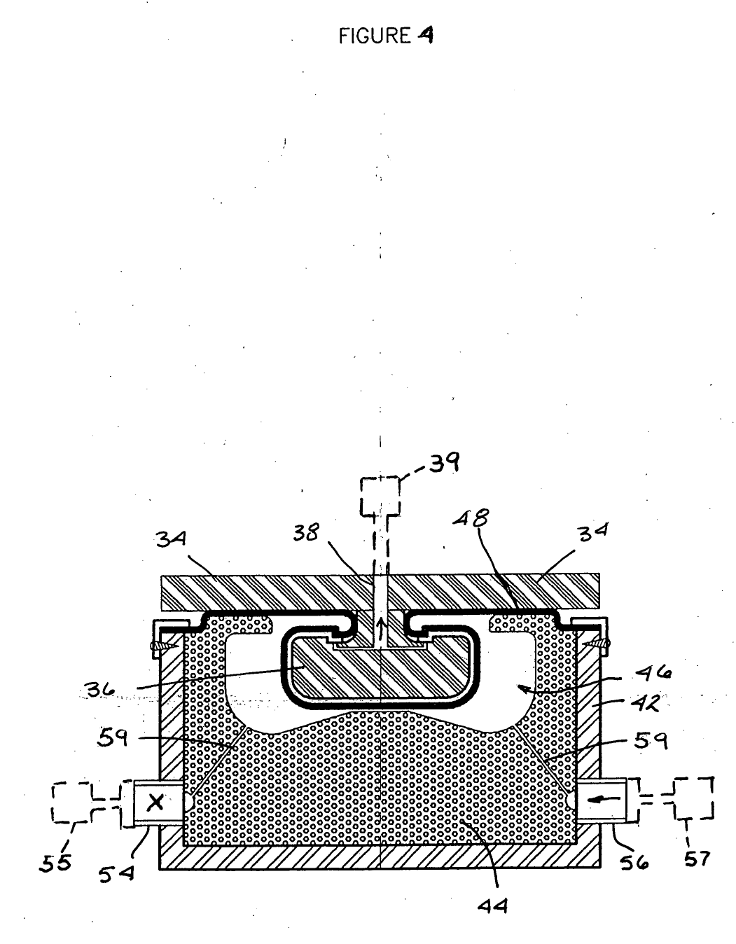

The form tool 36 of male mold 32 fits in female mold 40, which includes a bladder box 42 filled with a porous solid foam liner 44 having a cavity 46 formed therein in the shape of an expanded position of a bladder 48. Porous solid foam liner 44 is an open cell, ridged foam that is cut to the shape desired for the bladder during one step of the operation. Bladder 48 is a resilient, flexible sheet clamped at an outer periphery 49 by flanges 50 to the outer periphery of the bladder box. An interior portion 52 of the bladder fits in mold cavity 46 and is shaped generally in the shape of the armrest cover. Bladder 48 can be made of silicone or other elastic material. A closeable vacuum port 54 extends from the exterior to the interior portion of the bladder box. A closeable pressure port 56 also extends from the exterior to the interior portion of the bladder box. The vacuum port can be connected to a vacuum device 55, and the pressure port can be connected to a pressure source 57, both shown schematically in FIG. 4. Holes 59 are positioned in a ring around liner 44 to allow for a predictable vacuum flow or pressure from the vacuum and pressure ports 54 and 56 to interior cavity 46.

A general explanation of the operation of the cover molding equipment is as follows:

Tooling plate 32 and form tool 36 travel in a vertical direction when in operation. Form tool 36 provides the shape of the product cover 12.

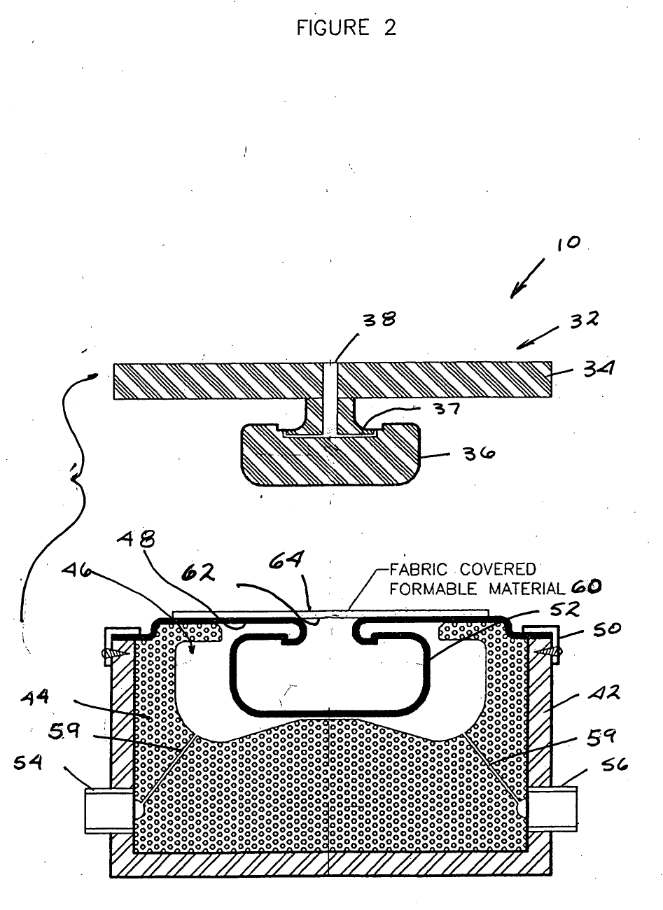

At the start of a manufacturing process, the tooling is in the position shown in FIG. 1, with the form tool in the upper position and the bladder in a relaxed state, as shown. The movement of the upper tooling can be accomplished in a pneumatic, hydraulic, or mechanical press, as is conventional in the art for flat bladder molding operations. The operational steps are described with respect to FIGS. 2-7.

A heated blank 60 in the form of a thermo formable sheet material is positioned in the bladder box, and vacuum is drawn in the interior of the cavity in the bladder box through vacuum port 54. The vacuum retracts the bladder outwardly prior to insertion of the form tool into the mold cavity. Preferably, the bladder is retracted before insertion of the heated blank into the mold.

The sheet material forming blank 60 can comprise a laminated sheet material having decorative outer layer 62 and a formable inner layer 64. The outer layer 62 desirably is a fabric but can be formed of other decorative surface material. The inner layer 64 is a formable (i.e., holds its shape when formed or molded) plastic material suitable for backing a fabric in the present invention. A relatively thin layer of cellular foam material such as a closed cell polypropylene foam or a composite material formed of polypropylene and polyethylene works well. The polypropylene affects the softness of the material. A layer of about one millimeter is desirable but a thickness ranging from about 0.75 to about two millimeters is satisfactory. A fabric surface layer can be laminated to the cellular foam layer by means of an adhesive. A heat activated film or web adhesive that is activated at about 300° F. is satisfactory.

As an alternative material for blank 60, polyvinyl chloride (“PVC” or “vinyl”) also can be used. Vinyl has desirable thermo forming characteristics and can be provided with a variety of finished or decorative surfaces. A vinyl layer thickness of about one to two millimeters and preferably about two millimeters in thickness is satisfactory. A thinner vinyl layer could be subject to tearing. A thicker vinyl layer could present forming difficulties on the form tool. Because vinyl is non-porous, an inner layer is not necessary for bleed through protection.

It should be noted that the present invention does not contemplate high pressure and high temperature conditions, such as those employed in an injection molding process. The armrest covers typically are formed at temperatures of about 275° to 325° F. for vinyl and fabric covers, respectively. The preferred armrest foam molding method of the present invention is a reaction injection molding (RIM) process, wherein temperature and pressures are substantially lower than in an injection molding process. A RIM process typically involves pressures of about 20 psi and temperatures in the range of about 120-150° F. and typically about 130° F. These temperatures and pressures are not high enough to damage fabric or to cause vinyl to release toxic chemicals. Thus, no backing material is essential for vinyl, and the backing layer for the fabric need not have the same level of thermal protection as a product used in an injection molding process. A relatively thin layer of closed cell foam or vinyl provides adequate thermal and bleed-through protection for the fabrics of the present invention and yet is sufficiently formable under moderate heat to hold the shape of a product cover when molded. These materials do not adversely alter the feel of the cushion. Other thermo formable backing materials also can be satisfactory.

The blank 60 used for the cover is first cut to a predetermined size. This formable material can be hot or cold at this point. The type of laminate material and the fabric shape used are determined for each fabric application.

Next, the blank is heated to make it pliable and then placed in the mold. For polypropylene, the temperature can be up to about 325° F. The temperature should be less than the melting temperature of the laminate adhesive.

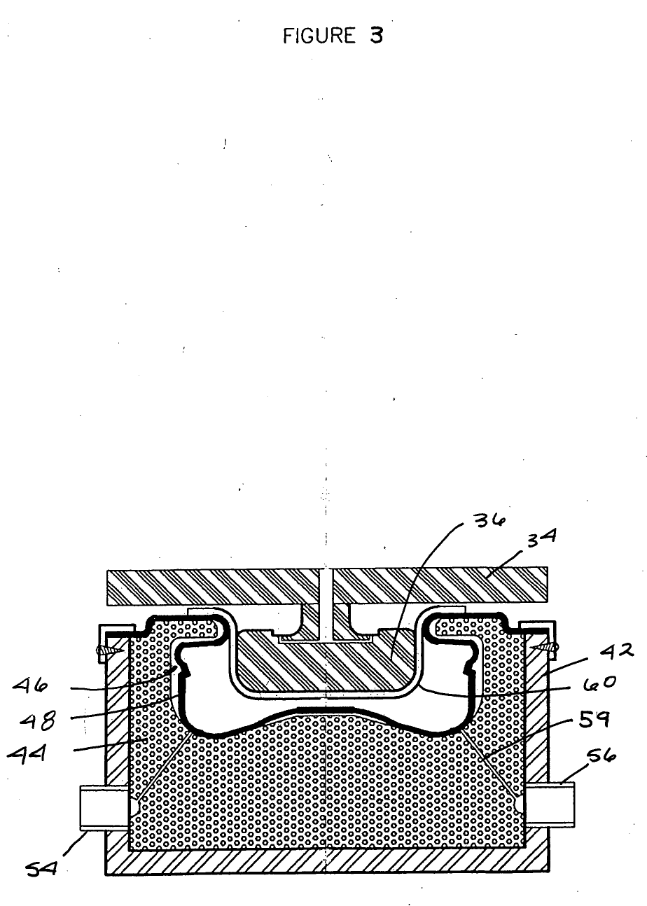

Referring to FIG. 3, with the bladder 48 drawn outwardly to its retracted state and the material blank positioned on the top of the bladder, form tool 36 is lowered into the mold cavity 46. As the form tool extends downwardly into the interior of cavity 46 in bladder box 42, blank material 60 wraps around the form tool. Form tool 36 continues down until the tooling plate 34 is firmly pressed against the top surface of the bladder 48 around the outer periphery of cavity 46. This forms an air-vacuum tight seal between the bladder surface and the tooling plate 34.

At this point, the vacuum is released from the bladder box 42 and vacuum port 54 is closed. Vacuum is then applied to the form tool 36 via the vacuum port 38 and vacuum source 39. At the same time, pressure is applied to the bladder box from pressure source 57 by means of pressure port 56. The external air pressure introduced through pressure port 56 and the vacuum drawn through vacuum port 38 cause the bladder to be drawn tightly around blank 60 and cause the blank to wrap tightly around form tool 36, in the manner shown in FIG. 4. At this time, all of the tool components are held as shown, and the vacuum and air pressure are maintained in order to allow the formable material to set into shape.

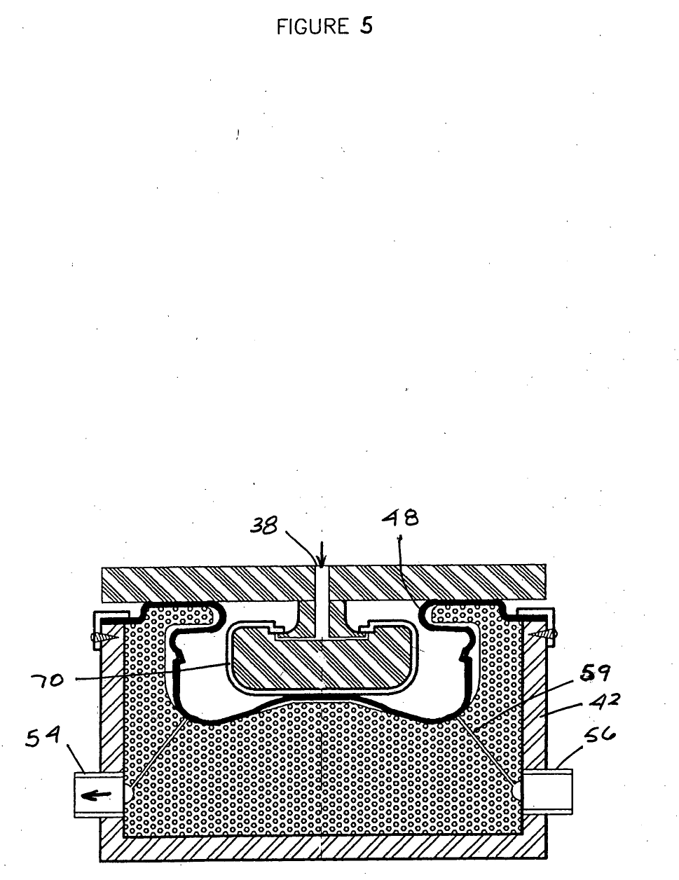

After the blank has set into its designed shape, pressure is removed from pressure port 56 in the bladder box, vacuum is released from port 38, and vacuum is applied to vacuum port 54. This causes bladder 48 to be pulled back and away from the form tool, leaving the formed blank on the form tool, as shown in FIG. 5.

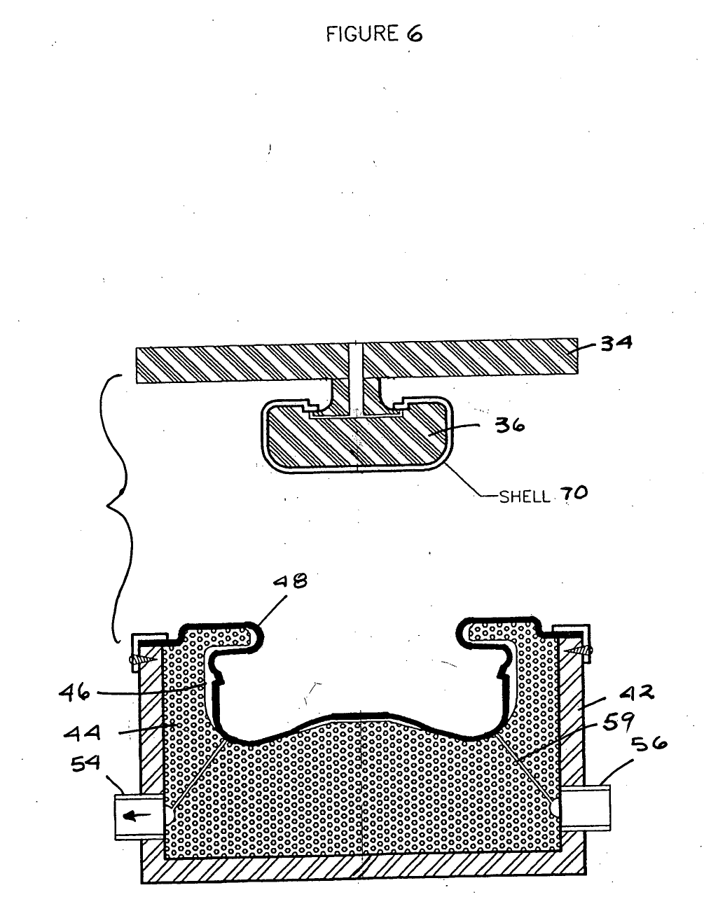

The form tool may then be withdrawn from the mold and raised to its upper position, shown in FIG. 6. The formed blank is now wrapped securely to the form tool and shaped in its desired form. At this point, the blank is no longer a blank but is now referred to as a shell 70.

At this point, the molding of the shell is complete. The shell can then be removed from form tool 36. This removal process can be manual or can be assisted by means of a mechanized removal apparatus. Pressure can be applied through vacuum port 38 in order to assist in the removal of shell 70 from the form tool.

With the shell removed, the entire tooling and bladder system is now positioned for the next cycle.

After the shell has been removed from the form tool, a substrate 26 formed of a more rigid material that is suitable for fastening an armrest to a chair arm or the like, is placed into the formed shell 12. The substrate can be an injection molded thermoplastic flange, as an example. Other types of substrates suitable for mating with a fastener are acceptable. The substrate can be adapted to receive a fastener therethrough or can be integrally molded with nuts therein, in a conventional manner.

The substrate is mechanically attached to the shell by frictional engagement between a ridge 61 on the flange that engages a stepped inner rim 63 on the shell.

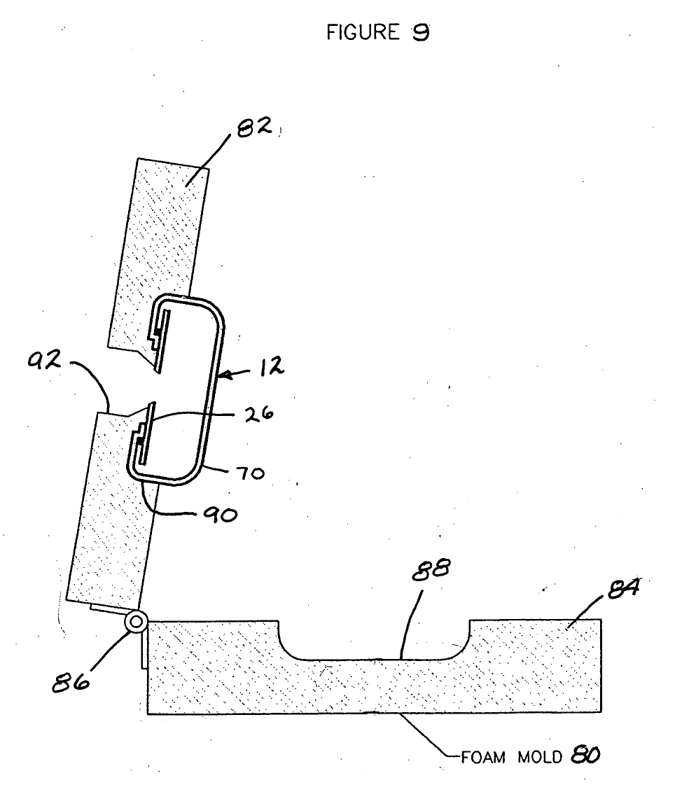

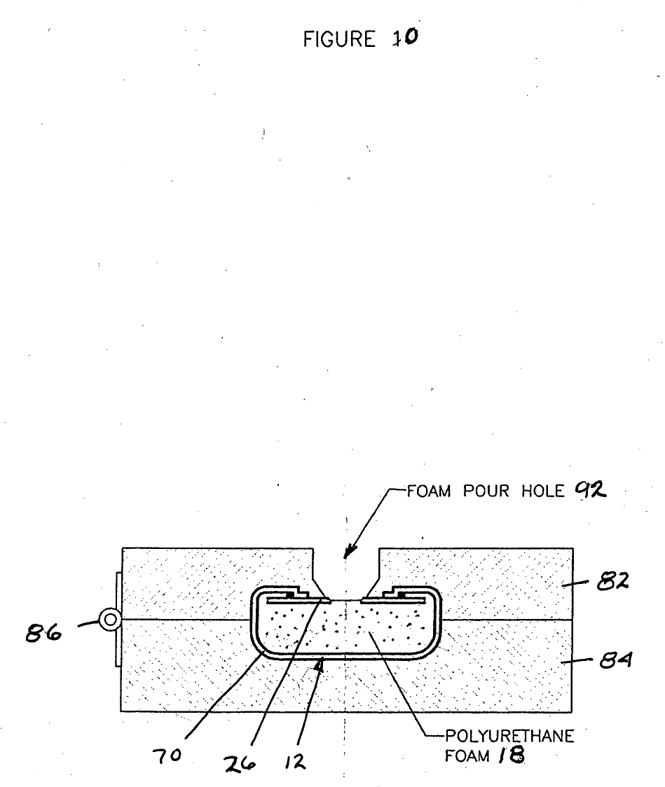

The shell with the attached substrate is now referred to as cover 12. The cover now is used in order to mold a complete armrest assembly, in accordance with the procedures set forth in FIGS. 9 and 10.

The completed cover 12 is first inserted in a foam mold 80 comprising an upper mold half 82 and a lower mold half 84 connected in the exemplary embodiment by a hinge 86. While a hinged tool is shown, various other means of closing the foam tool may be used. The mold includes a lower mold cavity 88 in the lower mold half 84 and an upper mold cavity 90 in the upper mold half 82. Since the molding process is a reaction injection molding process and does not involve high temperatures and pressures, mold 80 does not require the same tool steel construction as a pressure injection mold. The upper mold half is provided with a pour hole 92 for pouring liquid foamable materials into the interior cavity of the mold.

As a first step in the product molding process, the formed armrest cover 12 is first positioned in the upper part of the foam mold 80. Conventional holding devices (not shown) in the upper part of the foam mold hold the cover in place. These holding devices serve both to hold the cover in place and to seal the cover against the top portion of the foam mold tool and against the substrate 26 in order to create a seal that prevents “bleed-through” of the polyurethane foam to the outer surface of the cover when the foam is in its liquid state.

As shown in FIG. 10, after the cover has been mounted in the upper part of the mold, the mold tool is closed and locked in its closed position. A two component polyurethane foam is then injected into the interior of the cover through pour hole 92. After the liquid has been injected in the interior of the shell, the pour hole is closed in order to seal the foam mold 80 in a closed cavity condition. The foam mold remains closed until the two component foam has reacted and the foam has expanded, filling the mold cavity, and set. The amount of time that the mold must remain closed varies with the foam formulation and mold and is conventional.

After the foam has been permitted to set, the product is finished. The completed armrest 14 is then removed from the mold and is ready to assemble to an armrest mounting surface, such as a chair arm 24, without additional labor to prepare it for mounting. Fasteners 28 can be used to attach the armrest to a chair.

The foregoing molding procedure produces a finished product that requires no further manufacturing procedures and requires no staples or other fasteners that render the product non-recyclable.

It should be recognized that while a preferred embodiment of the present invention has been shown and described, various changes and modifications in the arrangements and details of construction may be made without departing from the spirit and scope of the present invention.

1. A process for producing a cushioned product having a foam core and integral cover comprising:
molding a formed cover from a substantially non-porous formable sheet material in a vacuum forming operation, wherein the sheet is first heated to the point where it is pliable and formable and then the sheet is formed around a form tool in the shape desired using a bladder forming process, the formed shape including an open interior for an integral foam core;
placing the formed cover in a mold cavity of a low pressure reaction injection mold, closing the mold, and injecting reactive liquid foam components into the open interior of the cover in the mold cavity;
holding the mold closed until the foam expands to substantially fill the open interior of the cover, allowing the foam to cure until the foam core and cover become integrally attached without the use of fasteners; and
removing the foam core and cover from the mold as an integral product.

2. A process as in claim 1 wherein the cover comprises a laminate having a porous fabric outer layer and a thermo formable closed cell foam inner layer, with the layers being adhesively laminated together, the inner layer being sufficiently flexible that the inner layer does not adversely impair the softness characteristics of the foam cushion core, the inner layer being sufficiently non-porous that liquid foam does not bleed through the fabric before the foam has cured.

3. A process according to claim 2 wherein the inner layer comprises a sheet of thermo formable closed cell foam formed of a plastic resin.

4. A process as in claim 3 wherein the inner layer comprises one or more members from the group consisting of polypropylene and a composite of polypropylene and polyethylene.

5. A process as in claim 2 wherein the inner layer has a thickness of about 0.75 to about 2.0 millimeters.

6. A process as in claim 5 wherein the inner layer is about one millimeter thick.

7. A process as in claim 1 wherein the cover comprises a sheet of material that includes polyvinyl chloride.

8. A process as in claim 7 wherein the cover comprises a sheet of polyvinyl chloride having a decorated exterior surface finish.

9. A process as in claim 8 wherein the cover is formed from a sheet of material consisting substantially exclusively of polyvinyl chloride.

10. A process as in claim 1 wherein the foam comprises a polyurethane foam.

11. A process as in claim 1 wherein the heated, pliable sheet of the cover is formed to the shape of the form tool by a pressure assisted bladder molding process, wherein a flexible bladder surrounds the cover sheet and form tool and is drawn tightly against the cover sheet and form tool by a vacuum drawn through the form tool, the force of the bladder on the sheet material being assisted by the application of pressurized gas on the exterior of the bladder so as to press the bladder more tightly against the cover sheet material and the form tool.

12. A process as in claim 1 wherein a substrate for mounting the cushioned product to a support member is integrally molded in the cushioned product, the substrate being mechanically attached to the cover prior to the injection of the foam core therein.

13. A process as in claim 12 wherein the substrate is formed of a moldable plastic resin and forms a mounting flange at an inner side of the cushioned product.

14. A process as in claim 1 wherein the sheet used to form the cover comprises a single layer of polyvinyl chloride having a thickness of about one to about two millimeters, the sheet having a decorative surface finish on an exterior surface thereof.

15. A process as in claim 1 wherein the cover comprises a decorative fabric outer layer and a flexible, substantially non-porous inner layer bonded thereto by a thermally active adhesive, the cover being molded at a temperature less than the melting point of the adhesive, the molding process by which foam cushioning is molded in the interior of the cover being performed at a temperature less than the melting point of the adhesive.

16. A process as in claim 15 wherein the cover is molded in the cover at a temperature of about 120° F. to 150° F. and a pressure of a conventional reaction injection molding process.

17. A process as in claim 16 wherein the cover is molded at a pressure of about twenty pounds per square inch.

18. A process as in claim 16 wherein the cover is formed without melting the plastic resin in the formable sheet material, the formable sheet material being pre-heated to a temperature of no more than about 325° F.
